(19) United States
(12) Patent Application Publication
(10) Pub. No.: US 2014/0179306 A1
(43) Pub. Date: Jun. 26, 2014

(54) Method of Routing of Data Messages from Mobile Devices Through Satellite and Terrestrial Communication Networks

(71) Applicant: Thomas Ronald Tessier, Winnipeg (CA)

(72) Inventor: Thomas Ronald Tessier, Winnipeg (CA)

(21) Appl. No.: 14/046,627

(22) Filed: Oct. 4, 2013

Related U.S. Application Data
(60) Provisional application No. 61/709,368, filed on Oct. 4, 2012.

(51) Int. Cl. H04W 84/06

(52) U.S. Cl. CPC H04W 84/06
USPC 455/428

(57) ABSTRACT

A telephone network provides a system which overcomes the problems with roaming charges and loss of service encountered by users by providing an alternate data message path through Low Earth Orbit (LEO) satellite networks such as Iridium Satellite or Globalstar, or through geosynchronous satellite networks such as Terrestar or Inmarsat. The system includes a cellular telephone handset enhancement to include specific satellite network communication capabilities that work in unison with a novel message routing system to handle the multiple message transport paths available for use by the cellular telephone. Each field user device includes a message exchange delivery algorithm which operates to set the delivery route of messages to select either the cellular telephone network or the satellite network.

This application claims the benefit under 35 USC 119(e) of Provisional application 61/709,368 filed Oct. 4, 2012.

This invention relates to a telephone network which allows routing of data messages from mobile devices through satellite and terrestrial communication networks.

Users of cellular telephones who travel to areas outside of their home areas often incur significant charges for roaming fees that are levied when the user must use the services of a distant cellular network. Likewise, when a user travels to an area that either does not have a roaming agreement with their home cellular service provider or are in an area which is not in range of any cellular services whatsoever, the user loses all cellular services with their device.

### SUMMARY OF THE INVENTION

According to the invention there is provided a telephone network comprising:

a cellular telephone network capable of sending and receiving data messages with identifiable radio transceiver devices;

a satellite network capable of sending and receiving data addressed to and from single identifiable radio transceiver devices;

a plurality of field user radio transceiver devices each capable of two-way communications with the cellular telephone network and with the satellite network;

a network management resource for controlling communication of messages on the network;

each field user device including a message exchange delivery algorithm which operates to set the delivery route of messages to select either the cellular telephone network or the satellite network.

Preferably the field user device is arranged to send control messages defining said delivery route to said point of contact according to the rules of the algorithm.

Preferably the delivery route of communication between the point of contact and each field user device is controlled solely by the message exchange delivery algorithm of the respective field user device.

Preferably there is provided a message delivery and reception status repository at the point of contact containing a table to record and report the status of each message to and from each field user device.

Preferably the field user device is arranged to send control messages to the message delivery and status repository at the point of contact according to the rules of the algorithm.

Preferably the message delivery and status repository at the point of contact is arranged such that a message delivery acknowledgement message is sent to the field user device when the control message is received from the field unit device.

Preferably the field user device is arranged to receive the acknowledgement so that the full handshake has occurred so that all messages produced by the field user device are routed through the chosen network.

Preferably the field user devices are arranged such that an active communication path control message is created by the algorithm which contains the delivery route currently selected by the field user device.

Preferably the active communication path control message of the field user device defines the network to be used for all messages to be exchanged with that field user device.

Preferably the field user device is arranged such that, when that field user device receives an acknowledge message from the point of contact, all messages between the point of contact and that field user device continue to use the selected network until such time that the field user device sends another active communication path control message to change the route to a different network.

Preferably the field user device is arranged such that when the network is changed to a different network, the process repeats itself and the different network is stored.

Preferably the field user device is arranged such that the message exchange delivery algorithm which operates to set the delivery route of messages to select either the cellular telephone network or the satellite network is initiated by one or more of powering up the device, a user manually requesting to change networks, or a timeout.

Preferably the field user device is arranged such that the message exchange delivery algorithm operates to set the delivery route of messages to select either the cellular telephone network or the satellite network if the network used previously is not available.

In one preferred arrangement each field user device is able to communicate with the satellite network by having components to communicate with said satellite network integrated within the physical case of the field user device.

However in alternative arrangements, each field user device is able to communicate with the satellite network by having components to communicate with said satellite network in an accessory as a direct attachment to the field user device or each field user device is able to communicate with the satellite network by having components to communicate with said satellite network in an accessory having a wireless link with the field user device.

The field user device operates by means of software within the field user device that configures electronics capable of operating in ranges of radio frequencies and communication protocols to operate on said satellite frequencies and protocol as well as cellular frequencies and protocols, or by means of the addition of electronic components specifically for operation on the satellite frequency and with the satellite communication protocols.

The arrangement as described hereinafter therefore provides a telephone network which is arranged to provide a system which overcomes these problems by providing an alternate data message path through Low Earth Orbit (LEO) satellite networks such as Iridium Satellite or Globalstar, or through geosynchronous satellite networks such as Terrestar or Inmarsat. The system presented in this patent includes a cellular telephone enhancement to include specific satellite network communication capabilities that work in unison with a novel message routing system to handle the multiple message transport paths available for use by the cellular telephone. This complete system overcomes the problems with roaming charges and loss of service encountered by users, such as network malfunctions or operating outside the area of a cellular service provider which could otherwise provide services.

### BRIEF DESCRIPTION OF THE DRAWINGS

FIG. 1 is a schematic illustration of components of a telephone network according to the present invention.

FIG. 2 is a flow chart of the algorithm for operating the telephone network of claim 1.

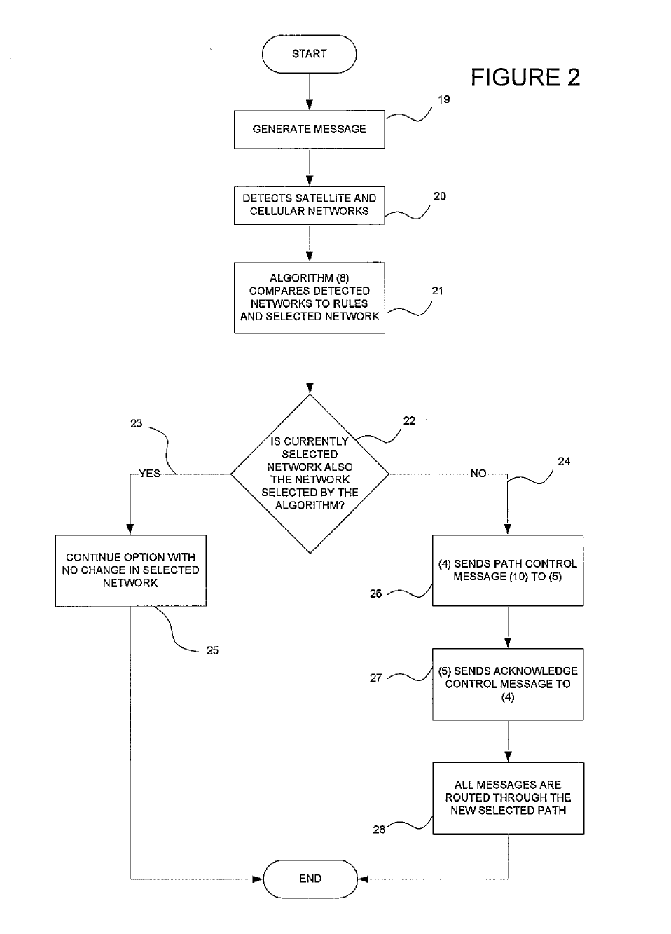

### DETAILED DESCRIPTION

Definitions: Messages originating in the field user device 4 to a network path are Mobile Originated (MO) messages, while messages routed to the field user device 4 are Mobile Terminated (MT) messages.

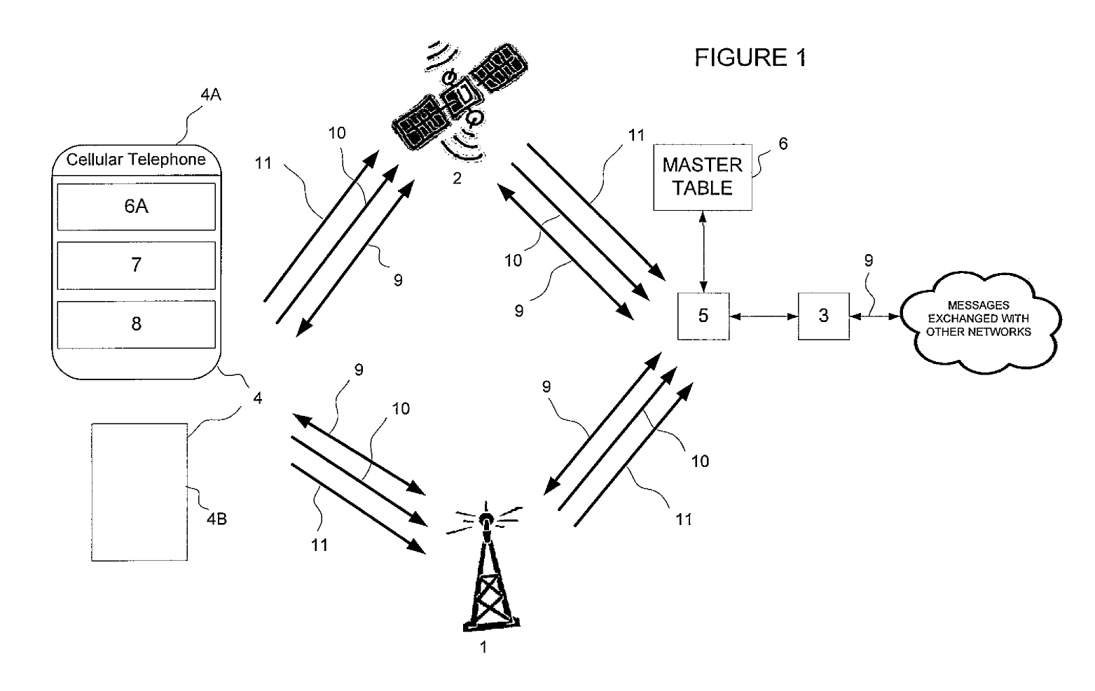

The following components are illustrated in FIG. 1:

A cellular telephone network 1 capable of sending and receiving data messages 9 such as Short Message Service (SMS) messages with identifiable radio transceiver devices 4 on the cellular network;

A satellite network 2 capable of sending and receiving data addressed to and from single identifiable radio transceiver devices 4;

A point of contact or multiple points of contact 3 act as gateways to other networks, and can be such devices as an SMS gateway or Short Message Service Center (SMSC), each with the capability to receive and send and otherwise exchange and relay data messages 9 with other points of contact and/or networks of data message exchange mechanisms, such as the worldwide SMS message service;

A plurality of field user devices 4 including specific devices 4A and 4B each capable of two-way communications with the cellular telephone network 1 and the satellite network 2;

A network management resource 5 which acts as a message delivery and reception status repository 5 to control and track exchanges of messages on the network. This contains a master table 6 to record and report the status of all messages to and from each field user device set up to use the particular message delivery and reception status repository. This repository lists the messages sent to each field user device 4 and the messages received from the field user device 4. The repository 5 stores at table 6 the status of each message in order that each message can be sent or re-sent as needed to either the field user device 4 or the point of contact relay 3 until such time that either the receiving field user device 4 or the point of contact relay 3 confirms the reception of each message.

Likewise, the repository 5 is capable of confirming to the field user device 4 or the point of contact relay 3 mechanism with messages that the repository 5 has received messages from each source. The repository 5 may contain in table 6 the messages themselves or only the status of messages that are stored in a different device, such as a Short Message Service Center (SMSC).

A message delivery and reception status table 6A is also maintained in each field user device 4 to maintain the status of each message sent and received by that field user device 4 with the cellular network 1 and satellite network 2 delivery paths.

A field user device status repository 7 is provided in each field user device 4 to maintain the status of that field user device 4 with respect to the routing for messages to each field user device 4. This field user device status repository 7 contains at least the following information on each field user device 4:

A. The method of communication with the field user device 4, whether it is by a cellular telephone network 1 or by a satellite network 2.

B. If there are multiples of each type of communication network to reach the point of contact relay 3 possible, the identification of which cellular 1 or satellite 2 network to use.

C. A record of control messages received from each field user device 4 to indicate which radio communication means the field user device 4 is active on, with the time the control messages were received (the “timestamp” of the control message).

A message exchange delivery optimization algorithm 8 operates in each field user device 4. This algorithm is used to set the delivery route of messages and send control messages to the message delivery and status repository 5 according to the rules of the algorithm. The rules of the algorithm can be set automatically or by external control from a user of the field user device 4 or by control messages.

As shown in the Figures, the system operates at a selected one of the field user devices 4 in general as follows:

A data message 9 is generated at step 19 containing information to be conveyed as the payload of the transmission that is to be routed to a particular destination. The payload contains bytes of data that may comprise any number of information formats, including text or binary message data comprising such items as a computer file, voice recording, video recording, image data, or a combination of data formats.

The field user device operates to detect available satellite and cellular networks at step 20. A step 21 the algorithm 8 acts to compare the detected networks and operates to select a network according to the set rules.

At step 22 the field user device acts to determine whether the currently selected network is the same as that currently set by the algorithm for current messages and selects path 23 or path 24 depending on the answer.

In the event that the answer is “yes” the field user device continues operation on the selected network without change as indicated at step 25.

In the event that the answer is “no” an active communication path control message 10 is created by the field user device 4 containing the identification of the communication path currently chosen by the algorithm 8 of the field user device 4 for the exchange of data messages.

A message delivery status repository reception acknowledgement control message is created by the message delivery status repository 5 to indicate to the field user device 4 or point of contact 3 that a particular message has been received by the message delivery status repository 5.

On receipt of an acknowledgement of the message sent by message delivery status repository 5 to the field user device, the field user device generates at step 27 a message reception acknowledgement control message 11 to confirm to the message delivery status repository 5 that a particular message has been received. This control message 11 contains the message identifier and optionally the time of reception of the particular message.

A message exchange delivery optimization algorithm control message at step 28 sets the parameters of the message exchange delivery optimization algorithm in the particular field user device and a field user device status message is sent in step 29 containing parameters of the message exchange delivery optimization algorithm 8, status of messages from the message delivery and reception status table 6 and any other status parameters as required from the field user device 4.

The arrangement herein thus provides a cellular telephone 4 with the novel capability to communicate though at least one cellular 1 and one satellite 2 communication path for data messages 9 is in use by a mobile user. The path of sending and receiving messages is determined by an optimization algorithm 8 in each field user device 4. The algorithm determines the message routing path to use according to pre-set parameters, and sends an active communication path control message 10 over the chosen network to signal the path for all messages to be exchanged with the field user device 4. Once the field user device 4 receives an acknowledge message from the message delivery status repository 5, all messages continue to use this path until such time that the field user device 4 sends another active communication path control message 10 to change the message route to a different path. When the path is changed, the process repeats itself and the new path is stored in both message delivery status repository 5 and message delivery and reception status table 6.

The message exchange optimization algorithm 8 consists of the following steps:

1. The process to detect the communication networks available begins. This can be initiated a number of ways, for example, by powering up the device, by a user manually requesting to change networks, or by a timeout.

2. The communication networks 1 and 2 are detected by monitoring the radio receivers on each network in the device. Determine which networks the device is registered on if necessary, by sending a request message to the detected network(s).

3. Compare the networks detected to the rules for operation.

4. Choose the network to operate on based on the rules for operation. For example, if the rules state that a particular cellular network is the highest priority for operation when detected, the algorithm chooses that network. In another example, if no cellular networks are detected but a specific satellite network is detected, the algorithm chooses the satellite network.

5. If the past network used previously is not available (due to checking on device power-up or if the user chooses a different network manually, for example) the process to choose the new network begins. An active communication path control message 10 is then sent through the chosen communication network to the message delivery and reception status repository 5. This step will ensure all messages bound for each specific device 4 are routed through the network the device had indicated it will be using in the control message 10. Therefore, all messages received in the future from the point of contact gateway or multiple points of contact gateways 3 will be routed to the field user device 4 through the correct network path.

6. A message delivery status repository reception acknowledgement control message is sent to the field user device 4 when the active communication path control message is received from the field unit device 4 by message delivery status repository 5.

7. The field user device 4 receives the acknowledgement from message delivery status repository 5. The full handshake has occurred, and now all messages produced by the field user device 4 will be routed through the chosen network.

8. Now that reception of the network change command is acknowledged, the network chosen is stored in the message delivery and reception status table 6 in the field user device 4.

9. If the field user device 4 does not receive an acknowledge message, and no other back-up network is available as defined in the algorithm 8, the active communication path control message 10 is re-transmitted or network requests are sent until such time that the acknowledgement is received or until a specified time-out.

10. According to the algorithm 8, other networks are checked for presence from time to time if the network in current use is not the highest priority network. At such time the highest priority network is detected and passes any quality parameters such as signal strength and time it has been available, the algorithm will send an active communication path control message 10 to advise the message delivery and reception status repository 5 of the intent to change networks. Once the acknowledgement message is received, the message delivery and reception status table 6 is updated.

Once a field user device 4 is registered on the corresponding message delivery and reception status repository for the system, data messages 9 and control messages are exchanged through the chosen network.

The field user device 4 is registered to a specific message delivery and reception status repository 5. The repository 5 is in turn registered to connect to one or more cellular network(s) 1 and one or more satellite network(s) 2. The repository 5 is also registered to connect to one or more point of contact or multiple points of contact 3 such as SMS gateway servers or SMSCs. An SMSC (or like device) may also serve as the path to the cellular network 1.

Messages bound for a field user device (MT messages) from outside the subscriber network are routed from some outside network such as an SMS gateway, where they are then routed directly to message delivery status repository 5 or point of contact 3. Regardless of whether the message is stored in message delivery status repository 5 or point of contact 3, the arrival of the data message is reported to the message queue controller in message delivery status repository 5. The message is then directed to be delivered over the current active network for the specific destination device. When the MT message is delivered to the field user device 4, a field user device message reception acknowledgement control message 11 is sent to message delivery status repository 5 to confirm reception. Once delivery is confirmed, the MT message in the queue is recorded as sent and moved to an archive.

Messages from a field user device (MO messages) bound for outside the subscriber network are sent from the field user device 4 through the selected network path to a message queuing in either point of contact 3 or message delivery status repository 5. The reception of the message is recorded in message delivery status repository 5. Message delivery status repository 5 then has a message delivery status repository reception acknowledgement control message sent to the field user device 4 that originally sent the message. Once the message is received at field user device 4, the message delivery and reception status table 6A in field user device 4 is updated to indicate the message sent is confirmed received, and moves the MO message to an archive.

When messages are sent between field user devices 4 on the same subscriber network, a combination of the MT and MO message exchanges are conducted, except messages are not sent or received through any point of contact or gateway 3 or otherwise required to be transmitted outside the local subscriber network.

In the case that a parameter of the algorithm 8 of a field user device 4 is to be changed remotely by control message sent to any particular field user device 4, message exchange delivery optimization algorithm control messages that each control a single parameter or multiple parameters may be sent. When these messages are received and processed by the field user device 4 and are successfully processed, a field user device status message is sent instead of a field user device message reception acknowledge control message 11. These status messages contain all or part of the parameters of the optimization algorithm 8.

1. A telephone network comprising:
a cellular telephone network capable of sending and receiving data messages with identifiable radio transceiver devices;
a satellite network capable of sending and receiving data addressed to and from single identifiable radio transceiver devices;
a network management resource for controlling communication of messages on the network;
a plurality of field user radio transceiver devices each capable of two-way communications through the cellular telephone network and though the satellite network to the network management resource;
each field user device including a message exchange delivery algorithm which operates to set the delivery route of messages to said network management resource to select either the cellular telephone network or the satellite network.

2. The network according to claim 1 wherein the field user device is arranged to send control messages defining said delivery route to said network management resource according to the rules of the algorithm.

3. The network according to claim 1 wherein the delivery route of communication between the network management resource and each field user devices is controlled solely by the message exchange delivery algorithm of the respective field user device.

4. The network according to claim 1 wherein there is provided a message delivery and reception status repository at the network management resource containing a table to record and report the status of each message to and from each field user device.

5. The network according to claim 4 wherein the field user device is arranged to send control messages to the message delivery and status repository at the network management resource according to the rules of the algorithm.

6. The network according to claim 5 wherein the message delivery and status repository at the network management resource is arranged such that a message delivery acknowledgement message is sent to the field user device when the control message is received from the field unit device.

7. The network according to claim 6 wherein the field user device is arranged to receive the acknowledgement so that the full handshake has occurred so that all messages produced by the field user device are routed through the chosen network.

8. The network according to claim 1 wherein the field user devices are arranged such that an active communication path control message is created by the algorithm which contains the delivery route currently selected by the field user device.

9. The network according to claim 8 wherein the active communication path control message defines the network to be used for all messages to be exchanged with that field user device.

10. The network according to claim 9 wherein the field user device is arranged such that, when that field user device receives an acknowledge message from the network management resource, all messages between the network management resource and that field user device continue to use the selected network until such time that the field user device sends another active communication path control message to change the route to a different network.

11. The network according to claim 10 wherein the field user device is arranged such that when the network is changed to a different network, the process repeats itself and the different network is stored.

12. The network according to claim 1 wherein the field user device is arranged such that the message exchange delivery algorithm which operates to set the delivery route of messages to select either the cellular telephone network or the satellite network is initiated by one or more of powering up the device, a user manually requesting to change networks, or a timeout.

13. The network according to claim 1 wherein the field user device is arranged such that the message exchange delivery algorithm operates to set the delivery route of messages to select either the cellular telephone network or the satellite network if the network used previously is not available.

14. The network according to claim 1 wherein each field user device is able to communicate with the satellite network by having components to communicate with said satellite network integrated within the physical case of the field user device.

15. The network according to claim 1 wherein each field user device is able to communicate with the satellite network by having components to communicate with said satellite network in an accessory as a direct attachment to the field user device.

16. The network according to claim 1 wherein each field user device is able to communicate with the satellite network by having components to communicate with said satellite network in an accessory having a wireless link with the field user device.

17. The network according to claim 1 wherein there is provided at least one point of contact with the capability, both through said cellular network and through the satellite network, to receive and send and otherwise exchange and relay data messages with other points of contact and/or networks of data message exchange mechanisms.
